(19) United States
(12) Patent Application Publication
(10) Pub. No.: US 2014/0073270 A1
(43) Pub. Date: Mar. 13, 2014

(54) TOUCH PANEL, DISPLAY APPARATUS AND ELECTRONIC APPARATUS HAVING INTEGRATED ANTENNA

(71) Applicant: JIENG TAI INTERNATIONAL ELECTRIC CORP., New Taipei City (TW)

(72) Inventors: Yu-Pang Chou, New Taipei City (TW); Pei-Zong Rao, New Taipei City (TW); Jyh-Hui Chang, New Taipei City (TW)

(73) Assignee: JIENG TAI INTERNATIONAL ELECTRIC CORP., New Taipei City (TW)

(21) Appl. No.: 14/019,556

(22) Filed: Sep. 6, 2013

(30) Foreign Application Priority Data
Sep. 7, 2012 (TW) 101132782
Aug. 26, 2013 (TW) 102130493

(51) Int. Cl. H04B 1/38

(52) U.S. Cl. CPC H04B 1/3827
USPC 455/90.2

(57) ABSTRACT

A touch panel includes a substrate, a sensing circuit, a circuit board module and a wireless circuit. The sensing circuit is disposed in a first area on a surface of the substrate and configured to receive a touch signal on the touch panel. The wireless circuit is disposed in a second area on the surface or disposed on a connection part of the circuit board module, and configured to receive/transmit a wireless signal. An electronic apparatus is also provided. A wireless circuit of the electronic apparatus includes a first antenna and a second antenna, which are disposed adjacent to a front side and a back side of the electronic apparatus, respectively. The wireless circuit is configured to receive/transmit a wireless signal selectively in the direction of the front side through the first antenna or in the direction of the back side through the second antenna.

### BACKGROUND OF THE INVENTION

1. Field of the Invention

The disclosed embodiments of the present invention relate to antenna disposition, and more particularly, to a touch panel having an antenna integrated therein, a related display apparatus and a related electronic apparatus.

2. Description of the Prior Art

Modern electronic products are increasingly smaller and more lightweight, resulting in insufficient space for disposing of antennas. To satisfy the need for a lightweight mobile phone, a laser direct structure (LDS) technology and a flexible printed circuit board (FPCB) may be used for disposing an antenna on an outer case of the mobile phone.

In order to transceive a specific physical wavelength, the antenna needs to have a specific size. Fabricating the antenna onto the outer case may increase the thickness of the mobile phone, and the fabrication cost may be increased due to the special process technology (e.g. the LDS technology).

### SUMMARY OF THE INVENTION

It is an objective of the present invention to provide a touch panel having an antenna integrated therein, a related display apparatus and a related electronic apparatus, which solve the above-mentioned problems.

According to an embodiment of the present invention, an exemplary touch pane is disclosed. The exemplary touch panel includes a substrate, a sensing circuit and a wireless circuit. The sensing circuit is disposed in a first area on a surface of the substrate, and is arranged for receiving a touch signal on the touch panel. The wireless circuit is disposed in a second area on the surface, and is arranged for transceiving a wireless signal.

According to another embodiment of the present invention, another exemplary touch pane is disclosed. The exemplary touch panel includes a substrate, a circuit board module, a sensing circuit and a wireless circuit. The circuit board module has a connection part disposed in a first area on a surface of the substrate. The sensing circuit is disposed in a second area on the surface of the substrate, and is arranged for receiving a touch signal on the touch panel and transmitting the touch signal through the circuit board module. The wireless circuit is disposed on the connection part of the circuit board module, and is arranged for transceiving a wireless signal through the circuit board module.

According to another embodiment of the present invention, an exemplary display apparatus is disclosed. The exemplary display apparatus includes a display panel, a circuit board module, and a wireless circuit. The display panel has a non-visible region. The circuit board module has a connection part disposed in the non-visible region. The wireless circuit is disposed in the non-visible region or on the connection part of the circuit board module, and is arranged for transceiving a wireless signal through the circuit board module.

According to another embodiment of the present invention, an exemplary electronic apparatus is disclosed. The exemplary electronic apparatus includes a housing, a display panel and a wireless circuit. The housing has a first surface and a second surface opposed to the first surface. The display panel is disposed on the first surface and has a non-visible region. The wireless circuit includes a first antenna and a second antenna. The first antenna is disposed in the non-visible region and near the first surface, the second antenna is disposed near the second surface, and the wireless circuit is arranged for transceiving a wireless signal selectively in the direction of the first surface through the first antenna or in the direction of the second surface through the second antenna.

The present invention provides a touch panel having a wireless circuit (e.g. a circuit having an antenna) integrated therein, a related display apparatus and a related electronic apparatus. Regarding a communication electronic product having a wireless circuit (e.g. a circuit having an antenna, wherein the antenna may be oriented toward the front side and/or the back side of the electronic apparatus), a space for disposing the wireless circuit may be released for further use. Therefore, not only may the size of the communication electronic product be reduced, but the additional cost of special processes may also be saved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an exemplary touch panel according to a first embodiment of the present invention.

FIG. 2 is a diagram illustrating an exemplary touch panel according to a second embodiment of the present invention.

FIG. 3 is a diagram illustrating an exemplary touch panel according to a third embodiment of the present invention.

FIG. 4 is a diagram illustrating an exemplary touch panel according to a fourth embodiment of the present invention.

FIG. 5 is a diagram illustrating an exemplary touch panel according to a fifth embodiment of the present invention.

FIG. 6 is a diagram illustrating an exemplary touch panel according to a sixth embodiment of the present invention.

FIG. 7 is a diagram illustrating an exemplary touch panel according to a seventh embodiment of the present invention.

FIG. 8 is a diagram illustrating an exemplary touch panel according to an eighth embodiment of the present invention.

FIG. 9 is a diagram illustrating an exemplary touch display apparatus according to a first embodiment of the present invention.

FIG. 10 is a diagram illustrating an exemplary touch display apparatus according to a second embodiment of the present invention.

FIG. 11 is a diagram illustrating an exemplary touch display apparatus according to a third embodiment of the present invention.

FIG. 12 is a diagram illustrating an exemplary touch display apparatus according to a fourth embodiment of the present invention.

FIG. 13 is a diagram illustrating an exemplary electronic apparatus according to a first embodiment of the present invention.

FIG. 14 is a diagram illustrating devices on a first surface and a second surface of the electronic apparatus shown in FIG. 13.

FIG. 15 is a diagram illustrating an exemplary electronic apparatus according to a second embodiment of the present invention.

FIG. 16 is a diagram illustrating devices on a first surface and a second surface of the electronic apparatus shown in FIG. 15.

### DETAILED DESCRIPTION

The concept of the present invention is to integrate a wireless circuit (e.g. a circuit having an antenna) and a panel. Regarding a communication electronic product having an antenna, a space for disposing the antenna may be released for further use. By way of example, but not limitation, the communication electronic product having the antenna may be a portable apparatus such as a smart phone, a notebook, a tablet personal computer, a personal navigation device (PND) and a global position system (GPS). In one implementation, the panel may be a touch panel. In another implementation, the panel may be a display panel. Further description is detailed as follows.

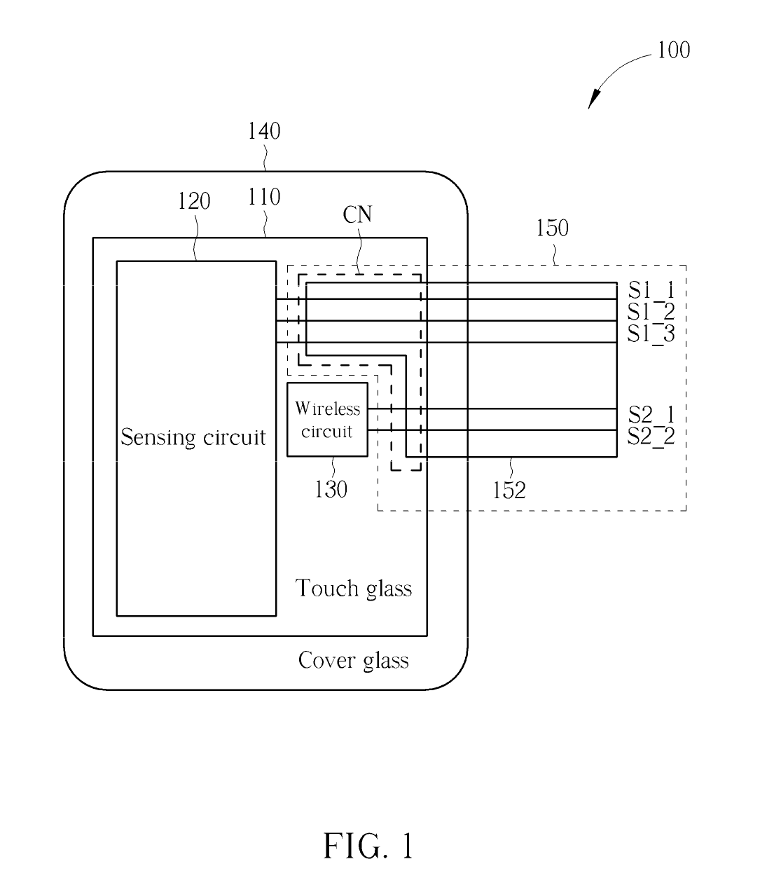

Please refer to FIG. 1, which is a diagram illustrating an exemplary touch panel 100 according to a first embodiment of the present invention. The touch panel 100 includes, but is not limited to, a touch glass 110, a sensing circuit 120, a wireless circuit 130 (e.g. a circuit having an antenna) and a cover glass 140. In this embodiment, the touch panel 100 has a glass-on-glass (G/G) structure. As shown in FIG. 1, the sensing circuit 120 is disposed in a first area on a surface of the touch glass 110, and is arranged for receiving a touch signal on the touch panel 100. The wireless circuit 130 is disposed in a second area on the surface of the touch glass 110, and is arranged for transceiving a wireless signal. As both the sensing circuit 120 and the wireless circuit 130 are disposed on the touch glass 110, a person skilled in the art should readily understand that the touch glass 110 may be disposed below the cover glass 140; the description and illustration of the stacked relationship of the elements shown in FIG. 1 are omitted here for brevity.

As the wireless circuit 130 is disposed in the second area of the touch panel 110, a coating technology (e.g. spray coating, printing or painting) may be utilized to dispose the wireless circuit 130 on the touch panel 110. In a case where the touch panel 100 is applied to a smart phone, an antenna of the smart phone may be integrated within an available area of the touch panel 100 rather than being disposed on an outer cover. Therefore, not only may the thickness of the smart phone be decreased, but the additional cost of the special process may also be saved.

In this embodiment, the touch panel 100 further includes a circuit board module 150, wherein the circuit board module 150 has a connection part CN disposed in a third area on the surface of the touch glass 110. Specifically, the sensing circuit 120, the wireless circuit 130 and the connection part of the circuit board module 150 are disposed in different respective areas on the surface of the touch glass 110. Additionally, the sensing circuit 120 may transmit the touch signal through the circuit board module 150, and the wireless circuit 130 may transceive the wireless signal through the circuit board module 150. In this embodiment, the circuit board module 150 may include a flexible printed circuit board 152, wherein the flexible printed circuit board 152 includes a first group of signal traces S1_{—}1-S1_{—}3 and a second group of signal traces S2_{—}1-S2_{—}2. The first group of signal traces S1_{—}1-S1_{—}3 may be used to transmit the touch signal. For example, a control circuit (not shown in FIG. 1) may be disposed on the flexible printed circuit board 152. Hence, the control circuit may control the sensing circuit 120 to detect a touch event through the first group of signal traces S1_{—}1-S1_{—}3, and the touch signal corresponding to the touch event may be transmitted to the control circuit through the first group of signal traces S1_{—}1-S1_{—}3 for identifying the touch event. In addition, the second group of signal traces S2_{—}1-S2_{—}2 may be used to transmit the wireless signal transceived by the wireless circuit 130.

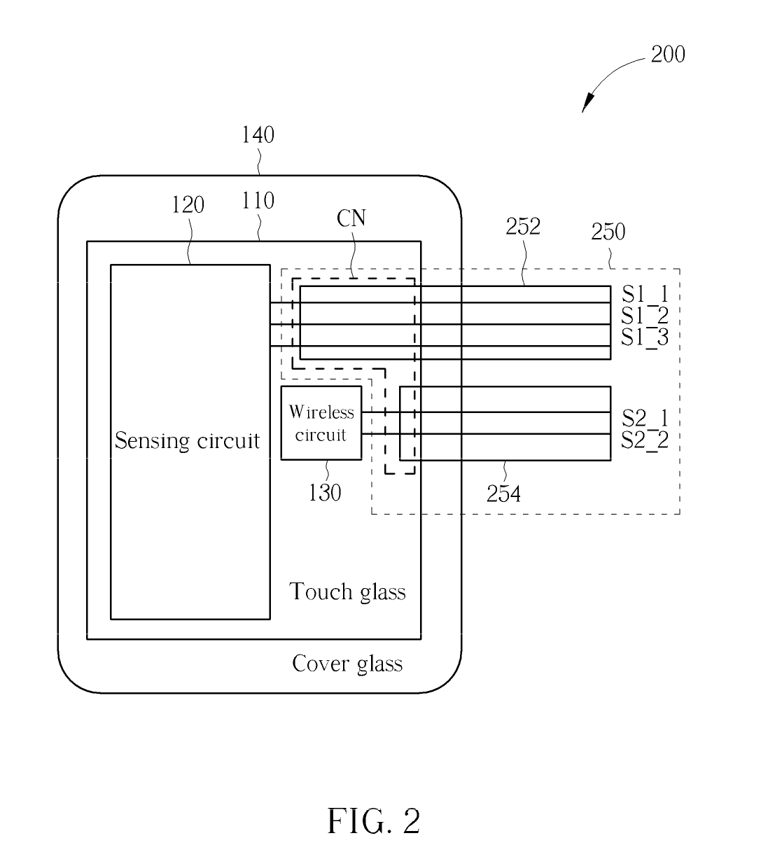

It should be noted that the above implementation of the circuit board module 150 is for illustrative purposes only, and is not meant to be a limitation of the present invention. Please refer to FIG. 2, which is a diagram illustrating an exemplary touch panel 200 according to a second embodiment of the present invention. The architecture of the touch panel 200 is based on that of the touch panel 100 shown in FIG. 1, with the major difference being the implementation of the circuit board module. Specifically, the circuit board module 250 included in the touch panel 200 includes a first flexible printed circuit board 252 and a second flexible printed circuit board 254, wherein the first flexible printed circuit board 252 and the second flexible printed circuit board 254 include the first group of signal traces S1_{—}1-S1_{—}3 and the second group of signal traces S2_{—}1-S2_{—}2, respectively. As in the touch panel illustrated in FIG. 1, the first group of signal traces S1_{—}1-S1_{—}3 is used to transmit the touch signal, and the second group of signal traces S2_{—}1-S2_{—}2 is used to transmit the wireless signal. Please note that the number of signal traces shown in FIG. 1 and FIG. 2 is for illustrative purposes only, and is not meant to be a limitation of the present invention. For example, the number of the signal traces coupled between the circuit board module 150 and the sensing circuit 120 shown in FIG. 1 depends on the actual design and requirements.

As shown in FIG. 1 and FIG. 2, the first group of signal traces S1_{—}1-S1_{—}3 and the second group of signal traces S2_{—}1-S2_{—}2 may be very close to each other, resulting in interference between the two groups of signal traces. In one implementation, the sensing circuit 120 may further perform a frequency shifting upon the touch signal. For example, the sensing circuit 120 may shift the frequency of the touch signal out of an operation frequency band of the wireless circuit 130. As a person skilled in the frequency shifting technique can readily understand that there are multiple options for implementing the above frequency shifting, further description is omitted here for brevity.

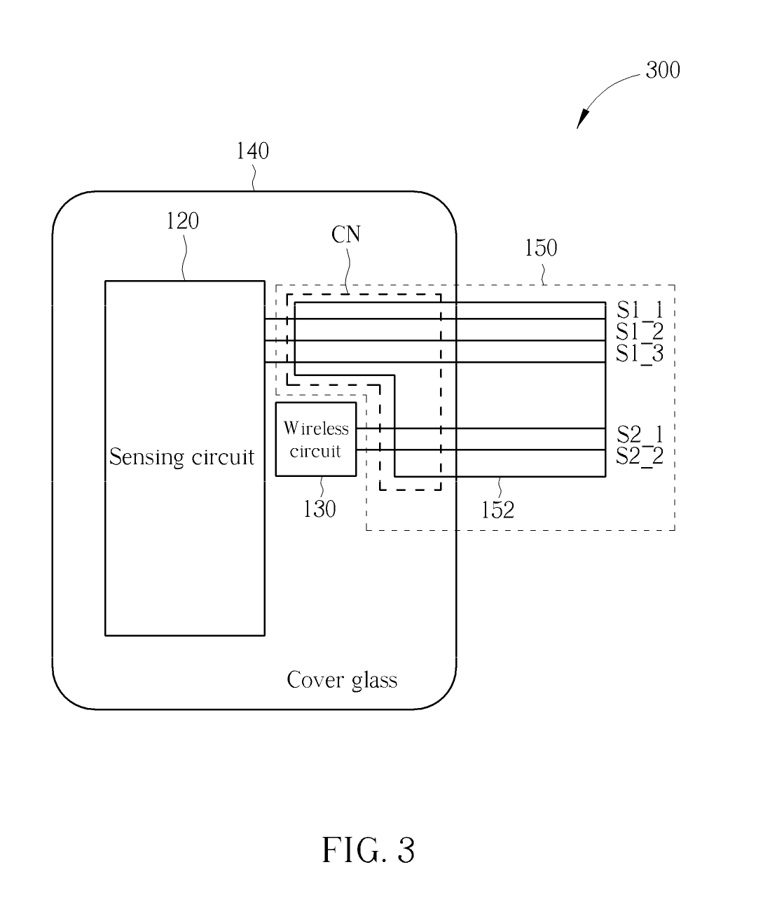

As mentioned above, the touch panel 100/200 shown in FIG. 1/FIG. 2 has a G/G structure. However, this is for illustrative purposes only, and is not meant to be a limitation of the present invention. For example, the concept of the present invention may be applied to a touch panel having a one glass solution (OGS) structure. Please refer to FIG. 3, which is a diagram illustrating an exemplary touch panel 300 according to a third embodiment of the present invention. The architecture of the touch panel 300 is based on that of the touch panel 100 shown in FIG. 1, with the major difference being that only a single glass substrate is needed to implement the touch panel 300. Specifically, in this embodiment, the sensing circuit 120 is disposed in a first area on a surface of the cover glass 140, and is arranged for receiving a touch signal on the touch panel 300. The wireless circuit 130 is disposed in a second area on the surface of the cover glass 140, and is arranged for transceiving a wireless signal. The connection part CN of the circuit board module 150 is disposed in a third area on the surface of the cover glass 140. The sensing circuit 120 may transmit the touch signal through the circuit board module 150 (i.e. the first group of signal traces S1_{—}1-S1_{—}3 on the flexible printed circuit board 152), and the wireless circuit 130 may transceive the wireless signal through the circuit board module 150 (i.e. the second group of signal traces S2_{—}1-S2_{—}2 on the flexible printed circuit board 152). As a person skilled in the art should readily understand the implementation of the OGS structure, the description and illustration of the stacked relationship of the elements shown in FIG. 3 are omitted here for brevity.

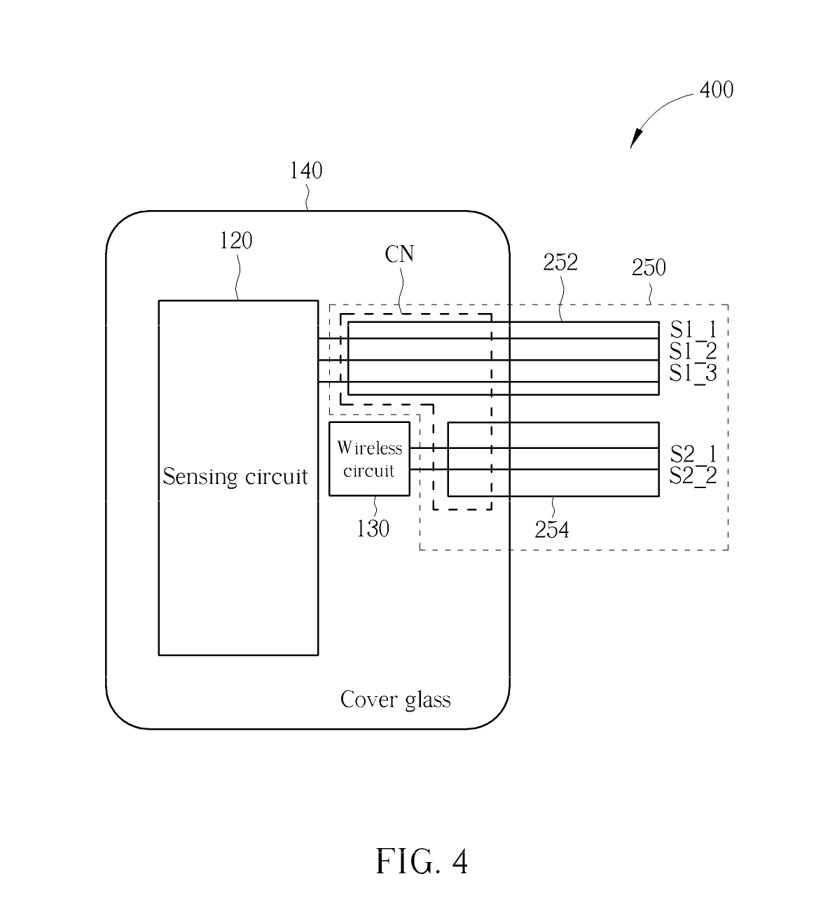

In one implementation, the circuit board module 150 of the touch panel 300 may also include a plurality of flexible printed circuit boards for signal transmission. Please refer to FIG. 4, which is a diagram illustrating an exemplary touch panel 400 according to a fourth embodiment of the present invention. The architecture of the touch panel 400 is based on the OGS structure of the touch panel 300 shown in FIG. 3 and the implementation of the circuit board module shown in FIG. 2. Specifically, the circuit board module 250 included in the touch panel 400 includes the first flexible printed circuit board 252 and the second flexible printed circuit board 254, wherein the first flexible printed circuit board 252 and the second flexible printed circuit board 254 include the first group of signal traces S1_{—}1-S1_{—}3 and the second group of signal traces S2_{—}1-S2_{—}2, respectively. Similarly, the first group of signal traces S1_{—}1-S1_{—}3 is used to transmit the touch signal, and the second group of signal traces S2_{—}1-S2_{—}2 is used to transmit the wireless signal. As a person skilled in the art can readily understand the operation principle of the touch panel 300/400 shown in FIG. 3/FIG. 4 after reading the description directed to FIG. 1 and FIG. 2, further description is omitted here for brevity.

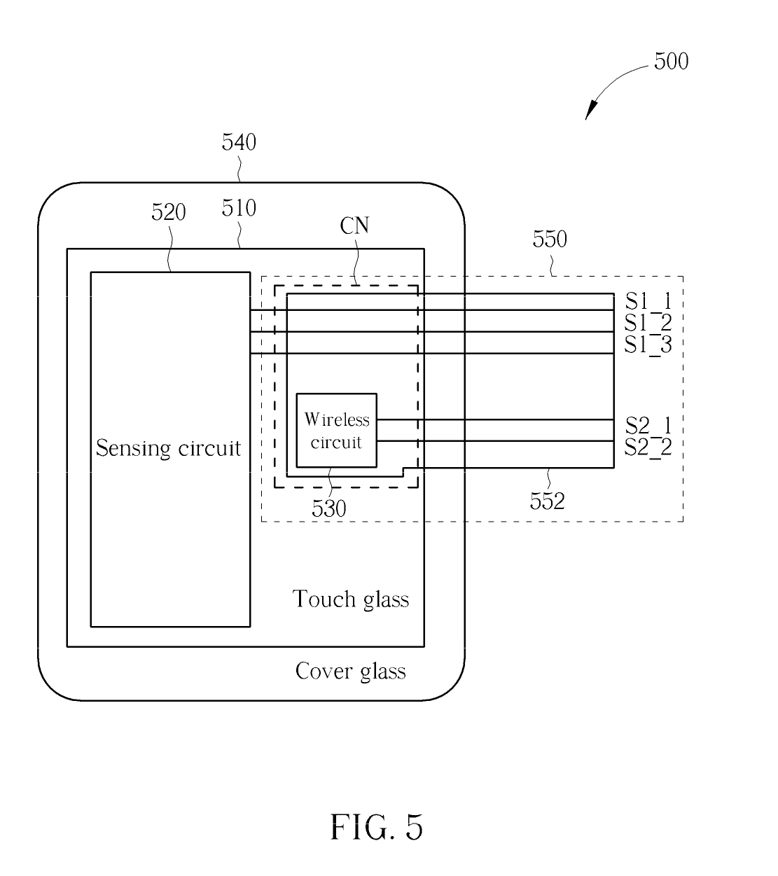

In brief, the sensing circuit and the wireless circuit may be disposed in different areas on the surface of the substrate (e.g. the touch glass or the cover glass) to integrate the wireless circuit into the panel. It is also feasible to dispose the wireless circuit onto the connection part of the circuit board module of the panel for integrating the wireless circuit into the panel. For example, in addition to the second area, the wireless circuit 130 shown in FIG. 1 may be disposed in the third area on the surface of the touch glass 110. Please refer to FIG. 5, which is a diagram illustrating an exemplary touch panel 500 according to a fifth embodiment of the present invention. The touch panel 500 may include, but is not limited to, a touch glass 510, a sensing circuit 520, a wireless circuit 530 (e.g. a circuit including an antenna), a cover glass 540 and a circuit board module 550. In this embodiment, the touch panel 500 has a G/G structure. As shown in FIG. 5, the circuit board module 550 has a connection part CN disposed in a first area on a surface of the touch glass 510. The sensing circuit 520 is disposed in a second area on the surface of the touch glass 510, and is arranged for receiving a touch signal on the touch panel 500 and transmitting the touch signal through the circuit board module 550. The wireless circuit 530 is disposed on the connection part CN of the circuit board module 550, and is arranged for transceiving a wireless signal through the circuit board module 550.

In this embodiment, the circuit board module 550 includes a flexible printed circuit board 552, wherein the flexible printed circuit board 552 may include a first group of signal traces S1_{—}1-S1_{—}3 and a second group of signal traces S2_{—}1-S2_{—}2. The first group of signal traces S1_{—}1-S1_{—}3 may be used to transmit the touch signal. For example, a control circuit (not shown in FIG. 5) may be disposed on the flexible printed circuit board 552. Hence, the control circuit may control the sensing circuit 520 to detect a touch event through the first group of signal traces S1_{—}1-S1_{—}3, and the touch signal corresponding to the touch event may be transmitted to the control circuit through the first group of signal traces S1_{—}1-S1_{—}3 for identifying the touch event. In addition, the second group of signal traces S2_{—}1-S2_{—}2 may be used to transmit the wireless signal transceived by the wireless circuit 530. As the wireless circuit 530 is disposed on the connection part CN of the circuit board module 550, the wireless circuit 530 and the control circuit, by way of example but not limitation, may be formed in the same process step. Hence, in a case where the touch panel 500 is employed in a smart phone, an antenna of the smart phone may be integrated within an available area of the touch panel 500 rather than disposed on an outer case, which may reduce the thickness of the smart phone and save the additional cost of the special process.

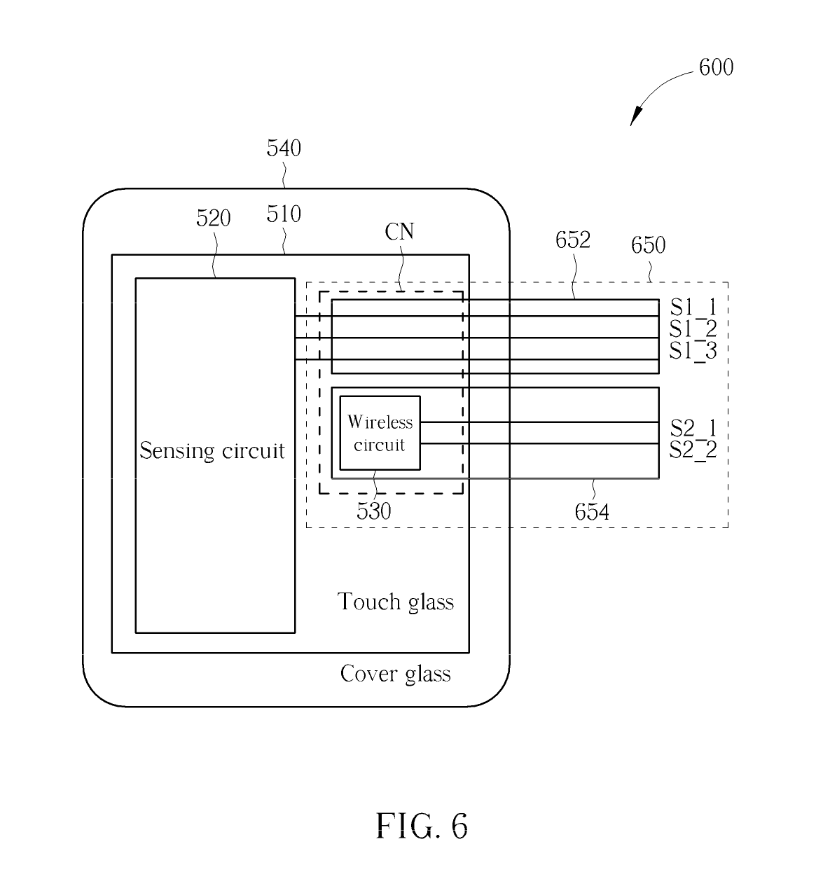

It should be noted that the above implementation of the circuit board module 550 is for illustrative purposes only, and is not meant to be a limitation of the present invention. Please refer to FIG. 6, which is a diagram illustrating an exemplary touch panel 600 according to a sixth embodiment of the present invention. The architecture of the touch panel 600 is based on that of the touch panel 500 shown in FIG. 5, with the major difference being the implementation of the circuit board module. Specifically, the circuit board module 650 included in the touch panel 600 includes a first flexible printed circuit board 652 and a second flexible printed circuit board 654, wherein the first flexible printed circuit board 652 and the second flexible printed circuit board 654 include the first group of signal traces S1_{—}1-S1_{—}3 and the second group of signal traces S2_{—}1-S2_{—}2, respectively. The first group of signal traces S1_{—}1-S1_{—}3 is used to transmit the touch signal, and the second group of signal traces S2_{—}1-S2_{—}2 is used to transmit the wireless signal. In addition, the number of the signal traces shown in FIG. 5 and FIG. 6 is for illustrative purposes only, and is not meant to be a limitation of the present invention. For example, the number of the signal traces coupled between the circuit board module 550 and the sensing circuit 520 shown in FIG. 5 depends on the actual design and specific requirements.

As shown in FIG. 5/FIG. 6, the first group of signal traces S1_{—}1-S1_{—}3 and the second group of signal traces S2_{—}1-S2_{—}2 may be very close to each other, resulting in interference between the two groups of signal traces. In one implementation, the sensing circuit 520 may further perform a frequency shifting upon the touch signal. For example, the sensing circuit 520 may shift the frequency of the touch signal out of an operation frequency band of the wireless circuit 530. As a person skilled in the frequency shifting technique can readily understand that there are multiple options for implementing the above frequency shifting, further description is omitted here for brevity.

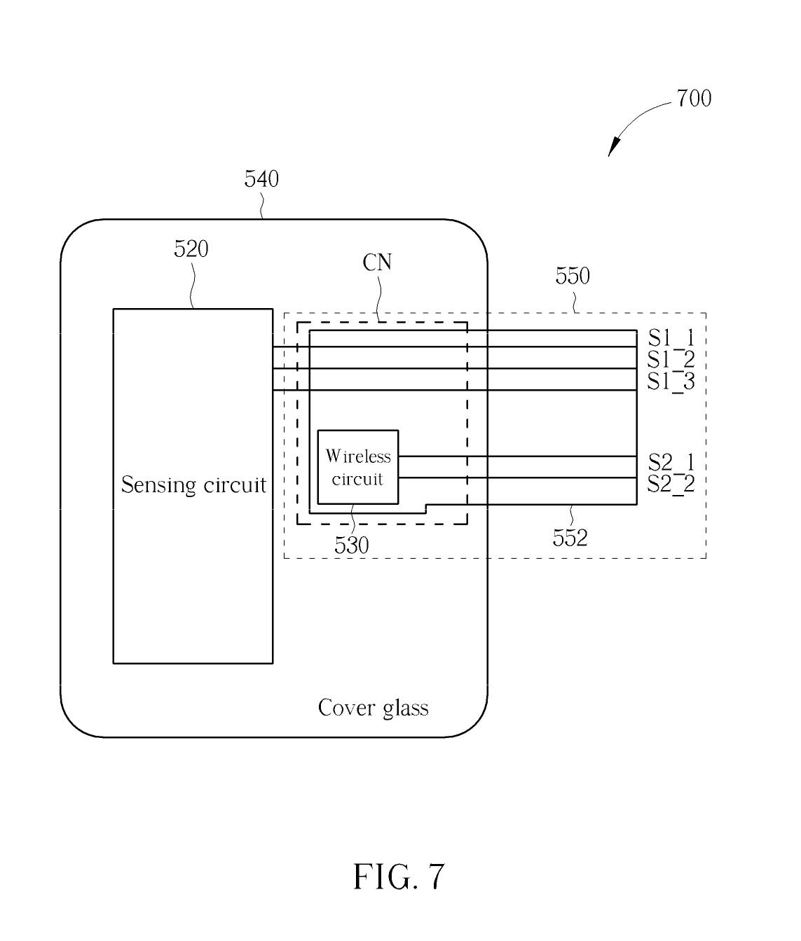

As mentioned above, the touch panel 500/600 shown in FIG. 5/FIG. 6 has the G/G structure. However, this is for illustrative purposes only, and is not meant to be a limitation of the present invention. For example, the concept of the present invention may be applied to a touch panel having an OGS structure. Please refer to FIG. 7, which is a diagram illustrating an exemplary touch panel 700 according to a seventh embodiment of the present invention. The architecture of the touch panel 700 is based on that of the touch panel 500 shown in FIG. 5, with the major difference being that only a single glass substrate is needed to implement the touch panel 700. Specifically, in this embodiment, the circuit board module 550 has a connection part CN disposed in a first area on a surface of the cover glass 540. The sensing circuit 520 is disposed in a second area on the surface of the cover glass 540, and is arranged for receiving a touch signal on the touch panel 700. The wireless circuit 530 is disposed on the connection part CN of the circuit board module 550, and is arranged for transceiving a wireless signal through the circuit board module 550.

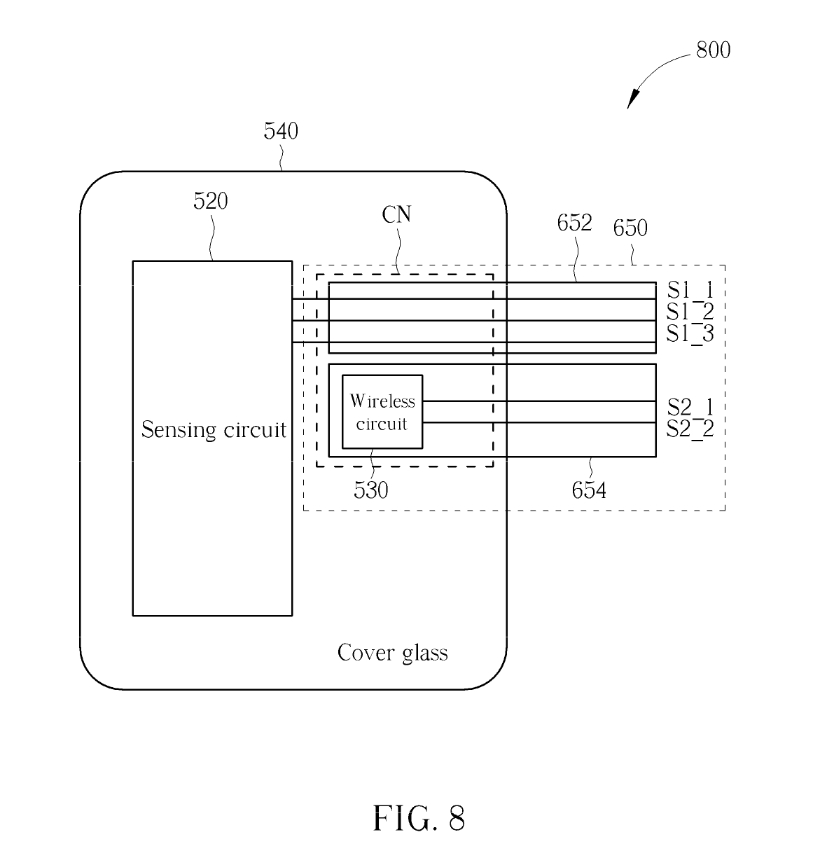

As shown in FIG. 7, the sensing circuit 520 may transmit the touch signal through the circuit board module 550 (i.e. the first group of signal traces S1_{—}1-S1_{—}3 on the flexible printed circuit board 552), and the wireless circuit 530 may transceive the wireless signal through the circuit board module 550 (i.e. the second group of signal traces S2_{—}1-S2_{—}2 on the flexible printed circuit board 552). In one implementation, the circuit board module 550 of the touch panel 700 may also include a plurality of flexible printed circuit boards for signal transmission. Please refer to FIG. 8, which is a diagram illustrating an exemplary touch panel 800 according to an eighth embodiment of the present invention. The architecture of the touch panel 800 is based on the OGS structure of the touch panel 700 shown in FIG. 7 and the implementation of the circuit board module shown in FIG. 6. Specifically, the circuit board module 650 included in the touch panel 800 includes the first flexible printed circuit board 652 and the second flexible printed circuit board 654, wherein the first flexible printed circuit board 652 and the second flexible printed circuit board 654 include the first group of signal traces S1_{—}1-S1_{—}3 and the second group of signal traces S2_{—}1-S2_{—}2, respectively. The first group of signal traces S1_{—}1-S1_{—}3 is used to transmit the touch signal, and the second group of signal traces S2_{—}1-S2_{—}2 is used to transmit the wireless signal. As a person skilled in the art can readily understand the operation principle of the touch panel 700/800 shown in FIG. 7/FIG. 8 after reading the description directed to FIG. 1-FIG. 6, further description is omitted here for brevity.

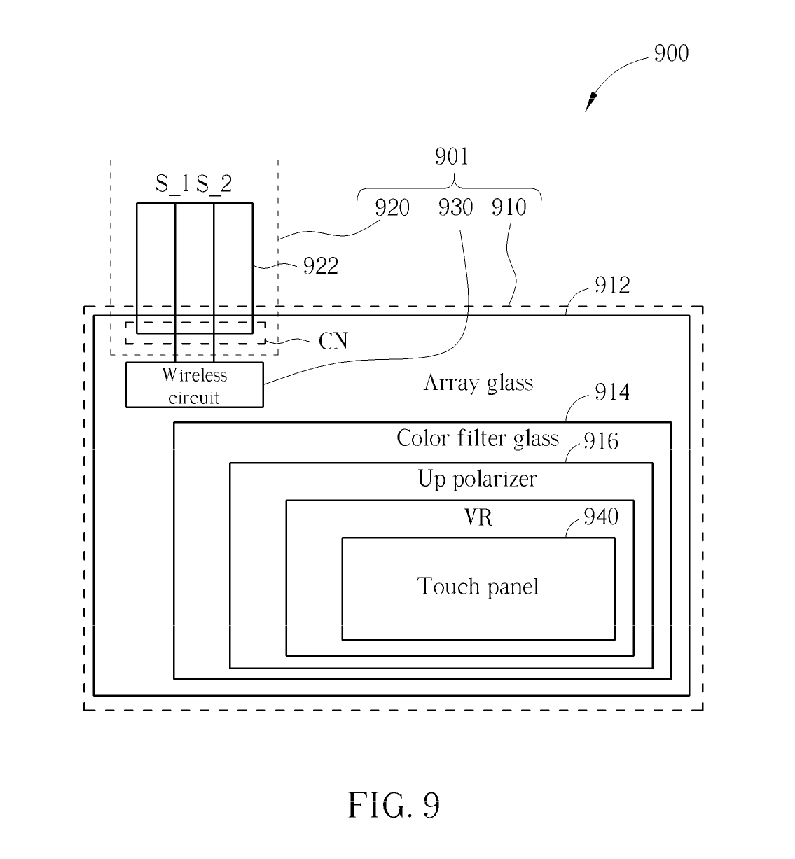

Besides the aforementioned touch panel, the panel for integrating the wireless circuit may be a display panel. Please refer to FIG. 9, which is a diagram illustrating an exemplary touch display apparatus 900 according to a first embodiment of the present invention. The touch display apparatus 900 may include, but is not limited to, a display module 901 and a touch panel 940. The display module 901 may include a display panel 910, a circuit board module 920 and a wireless circuit 930 (e.g. a circuit having an antenna). The display panel 910 has a visible region VR and a non-visible region (i.e. an area except for the visible region VR), and includes an array glass 912, a color filter glass 914 and an up polarizer 916. The circuit board module 920 has a connection part CN disposed in the non-visible region. The wireless circuit 930 is disposed in the non-visible region. More specifically, the wireless circuit 930 is disposed on the array glass 912 in this embodiment. The touch panel 940 is disposed in the visible region VR. In addition, the wireless circuit 930 is arranged for transceiving a wireless signal through the circuit board module 920.

The wireless circuit 930 is integrated into the display panel 910, and is arranged to transceive the wireless signal through signal traces S_{—}1 and S_{—}2 on the flexible printed circuit board 922 of the circuit board module 920. In an alternative design, the wireless circuit 930 may also be integrated into the touch panel 940. For example, the touch panel 940 may be implemented by the touch panels 100-800 shown in FIGS. 1-8. Please note that, for brevity and clarity, the relative position between the array glass 912, the color filter glass 914 and the up polarizer 916 in the display panel 910 is represented by device sizes shown in FIG. 9. Additionally, as a person skilled in the art should readily understand the basic structure of the display panel, the description of the stacked relationship of the elements shown in FIG. 9 and the related operation principle are omitted here for brevity.

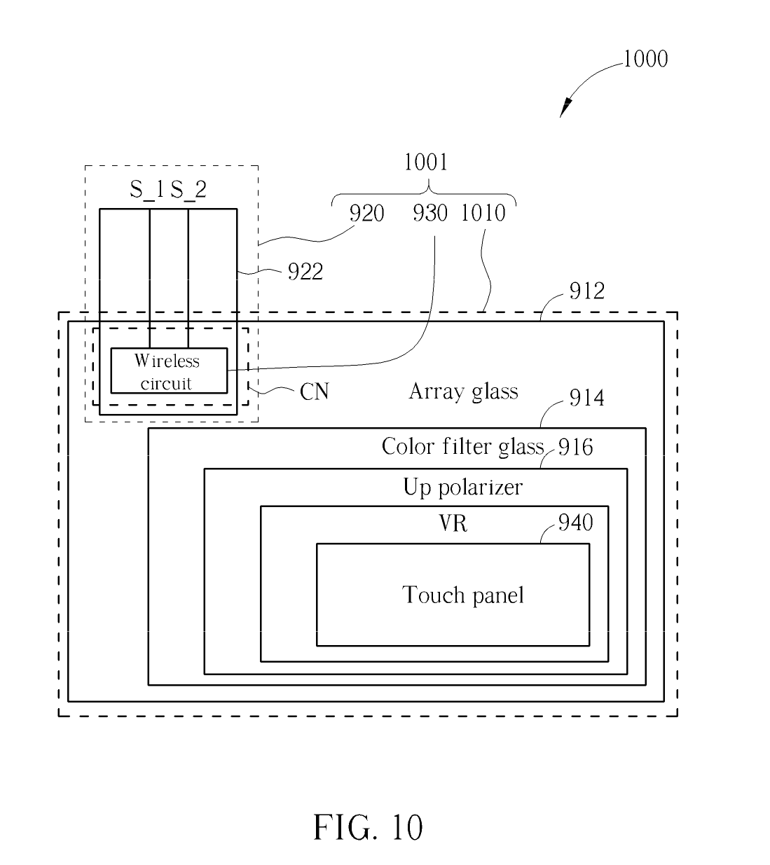

Please refer to FIG. 10, which is a diagram illustrating an exemplary touch display apparatus 1000 according to a second embodiment of the present invention. The architecture of the touch display apparatus 1000 is based on that of the touch display apparatus 900 shown in FIG. 9, with the major difference being that the wireless circuit 930 of the display module 1001 is disposed on the connection part CN of the circuit board module 920. In other words, the wireless circuit 930 may be disposed on the flexible printed circuit board 922 where the control circuit (not shown in FIG. 10) of the display panel 1010 is disposed.

The touch panel 940 shown in FIG. 9/FIG. 10 may also be integrated into the display panel 910/1010 (i.e. an in-cell/on-cell touch panel). Please refer to FIG. 11, which is a diagram illustrating an exemplary touch display apparatus 1100 according to a third embodiment of the present invention. The touch display apparatus may include, but is not limited to, a display panel 1110, a touch sensing module 1120, a circuit board module 1130 and a wireless circuit 1140 (e.g. a circuit having an antenna). The display panel 1110 has a visible region VR (e.g. a screen) and a non-visible region (i.e. an area except for the visible region VR), and includes an array glass 1112, a color filter glass 1114 and an up polarizer 1116. The touch sensing module 1120 is disposed in a position corresponding to the visible region VR in the display panel 1110. The circuit board module 1130 has a connection part CN disposed in the non-visible region. The wireless circuit 1140 is disposed in the non-visible region. More specifically, the wireless circuit 1140 is disposed on the array glass 1112 in this embodiment, and is arranged for transceiving a wireless signal through the circuit board module 1130.

It should be noted that the touch sensing module 1120 may be disposed on the array glass 1112 or the color filter glass 1114. For example, the touch sensing module 1120 may be integrated within a thin-film-transistor (TFT) array on the array glass 1112. In one implementation, the touch sensing module 1120 may also be disposed on a top surface or a bottom surface of the color filter glass 1114. In brief, in this embodiment, the wireless circuit 1140 is integrated into the display panel 1110, and is arranged to transceive the wireless signal through the signal traces S_{—}1 and S_{—}2 on the flexible printed circuit board 1132 of the circuit board module 1130. In an alternative design, the wireless circuit 1140 may also be integrated within the touch sensing module 1120. For example, the touch sensing module 1120 may be implemented by the touch panels 100-800 shown in FIGS. 1-8. Please note that, for brevity and clarity, the relative position between the array glass 1112, the color filter glass 1114 and the up polarizer 1116 in the display panel 1110 is represented by device sizes shown in FIG. 11. Additionally, as a person skilled in the art should readily understand the basic structure of the display panel, the description of the stacked relationship of the elements shown in FIG. 11 and the related operation principle are omitted here for brevity.

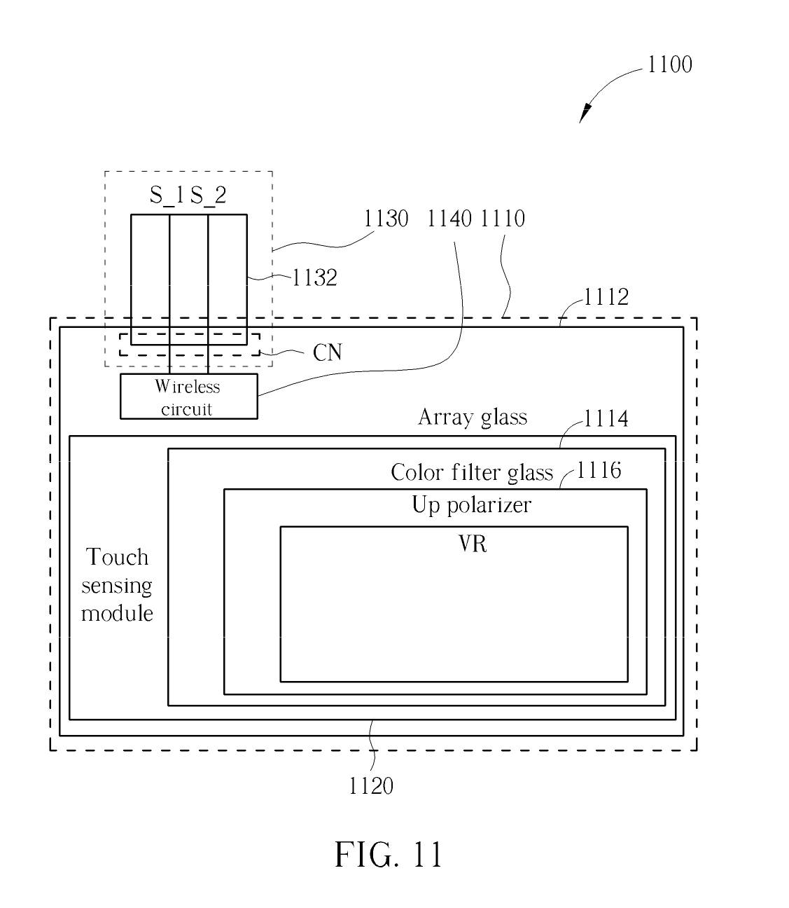

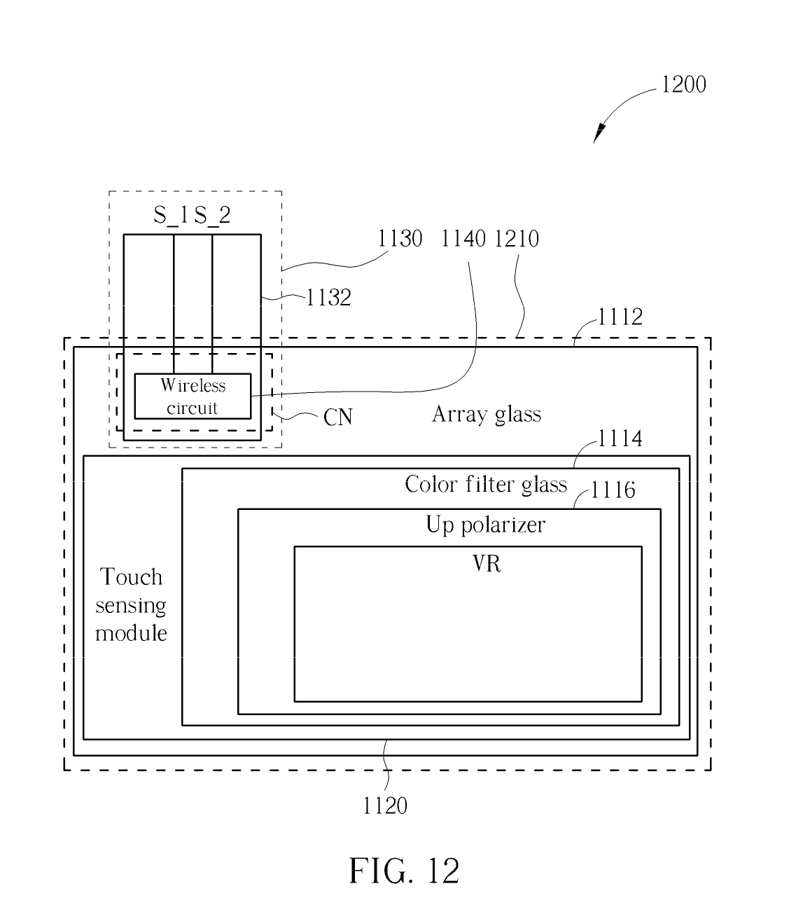

Please refer to FIG. 12, which is a diagram illustrating an exemplary touch display apparatus 1200 according to a fourth embodiment of the present invention. The architecture of the touch display apparatus 1200 is based on that of the touch display apparatus 1100 shown in FIG. 11, with the major difference being that the wireless circuit 1140 shown in FIG. 11 is disposed on the connection part CN of the circuit board module 1130. In other words, the wireless circuit 1140 may be disposed on the flexible printed circuit board 1132 where the control circuit (not shown in FIG. 12) of the display panel 1210 is disposed.

The touch display apparatus 900/1000/1100/1200 integrating the wireless circuit 930/1140 shown in FIG. 9/FIG. 10/FIG. 11/FIG. 12 may not include the touch panel 940/the touch sensing module 1120. This means that the concept of the present invention may also be applicable to a display apparatus without touch capability. In one implementation, the aforementioned display apparatus without touch capability may include a display panel, a circuit board module, and a wireless circuit. The display panel has a non-visible region; the circuit board module has a connection part disposed in the non-visible region; and the wireless circuit is disposed in the non-visible region or on the connection part of the circuit board module, and is arranged for transceiving a wireless signal through the circuit board module. After reading the description directed to FIGS. 1-12, a person skilled in the art should readily understand that, although the display apparatus without touch capability omits the touch panel 940/the touch sensing module 1120 shown in FIG. 9/FIG. 10/FIG. 11 /FIG. 12, the concept of integrating a wireless circuit (e.g. a circuit having an antenna) into a panel (e.g. a touch panel/a display panel) is the same, and therefore further description is omitted here for brevity.

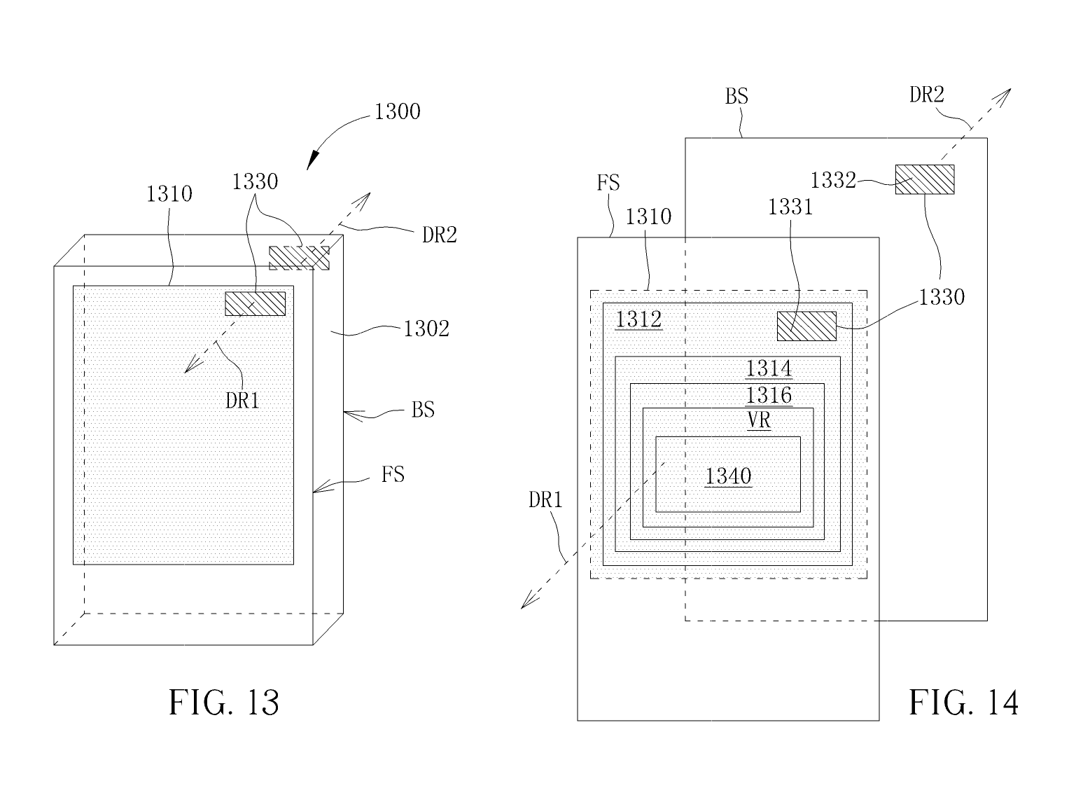

Please refer to FIG. 13 and FIG. 14 together. FIG. 13 is a diagram illustrating an exemplary electronic apparatus 1300 according to a first embodiment of the present invention, and FIG. 14 is a diagram illustrating devices on a first surface FS and a second surface BS of the electronic apparatus 1300 shown in FIG. 13. The electronic apparatus 1300 may include a housing 1302, a display panel 1310 and a wireless circuit 1330.

The housing 1302 may have the first surface FS and the second surface BS opposed to the first surface FS. In this embodiment, the first surface FS may be a front side of the electronic apparatus 1300, and the second surface BS may be a back side of the electronic apparatus 1300.

The display panel 1310 may be disposed on the first surface FS of the electronic apparatus 1300, and have a visible region VR and a non-visible region (i.e. an area except for the visible region VR). In one implementation, the display panel 1310 may further include optical devices such as an array glass 1312, a color filter glass 1314 and an up polarizer 1316.

The wireless circuit 1330 may include a first antenna 1331 and a second antenna 1332. The first antenna 1331 may be disposed in the non-visible region in the display panel 1310 and near the first surface FS. The second antenna 1332 may be disposed near the second surface BS. The wireless circuit 1330 may transceive a wireless signal selectively in the direction of the first surface FS (i.e. a first direction DR1) through the first antenna 1331 or in the direction of the second surface BS (i.e. a second direction DR2) through the second antenna 1332.

The first antenna 1331 may be disposed in the non-visible region. More specifically, the first antenna 1331 may be disposed on the array glass 1312 in this embodiment. The electronic apparatus 1300 may further include a touch panel 1340, which is disposed in the visible region VR. In brief, the first antenna 1331 may be integrated into the display panel 1310 on the first surface FS of the housing 1302. In an alternative design, the first antenna 1331 may be integrated into the touch panel 1340 on the first surface FS of the housing 1302. For example, the touch panel 1340 may be implemented by the touch panels 100-800 shown in FIG. 1-FIG. 8. Please note that, for brevity and clarity, the relative position between the optical devices of the display panel 1310 (e.g. the array glass 1312, the color filter glass 1314 and the up polarizer 1316) is represented by device sizes shown in FIG. 14. Additionally, as a person skilled in the art should readily understand the basic structure of the display panel, the description of the stacked relationship of the optical devices shown in FIG. 14 and the related operation principle are omitted here for brevity.

In this embodiment, the second antenna 1332 may be disposed in the housing 1302 and near the second face BS. For example, the second antenna 1332 may be embedded in a back cover of the electronic apparatus 1300, wherein the back cover may be a portion of the housing 1302.

It should be noted that each of the first antenna 1331 and the second antenna 1332 may be a near field communication (NFC) antenna device. A transmission/reception direction of the first antenna 1331 is directed to the front side of the electronic apparatus 1300 (e.g. the first direction DR1 of the first surface FS), and the first antenna 1331 is integrated within the non-visible region of the display panel 1310 (or the touch panel 1340) on the first surface FS of the housing 1302. Compared to a conventional antenna disposed inside a housing such as the housing 1302 (e.g. disposed on a printed circuit board in the center of the housing), fewer wireless signals will be shielded by the display panel 1310 (or the touch panel 1340) when the first antenna 1331 transmit/receive wireless signals towards/from the front side of the electronic apparatus 1300. In addition, a transmission/reception direction of the second antenna 1332 is directed to the back side of the electronic apparatus 1300 (e.g. the second direction DR2 of the second surface BS), and the second antenna 1332 is embedded in the back cover of the electronic apparatus 1300. Hence, when the second antenna 1332 transmit/receive wireless signals towards/from the back side of the electronic apparatus 1300, fewer wireless signals will be interfered by other electronic elements inside the electronic apparatus 1300.

The wireless circuit 1330 of the electronic apparatus 1300 may transceive a wireless signal selectively in the direction of the first surface FS (i.e. the first direction DR1) through the first antenna 1331 or in the direction of the second surface BS (i.e. the second direction DR2) through the second antenna 1332, thus allowing the electronic apparatus 1300 may perform near field communication in both directions (i.e. towards the front side and the back side of the electronic apparatus 1 300).

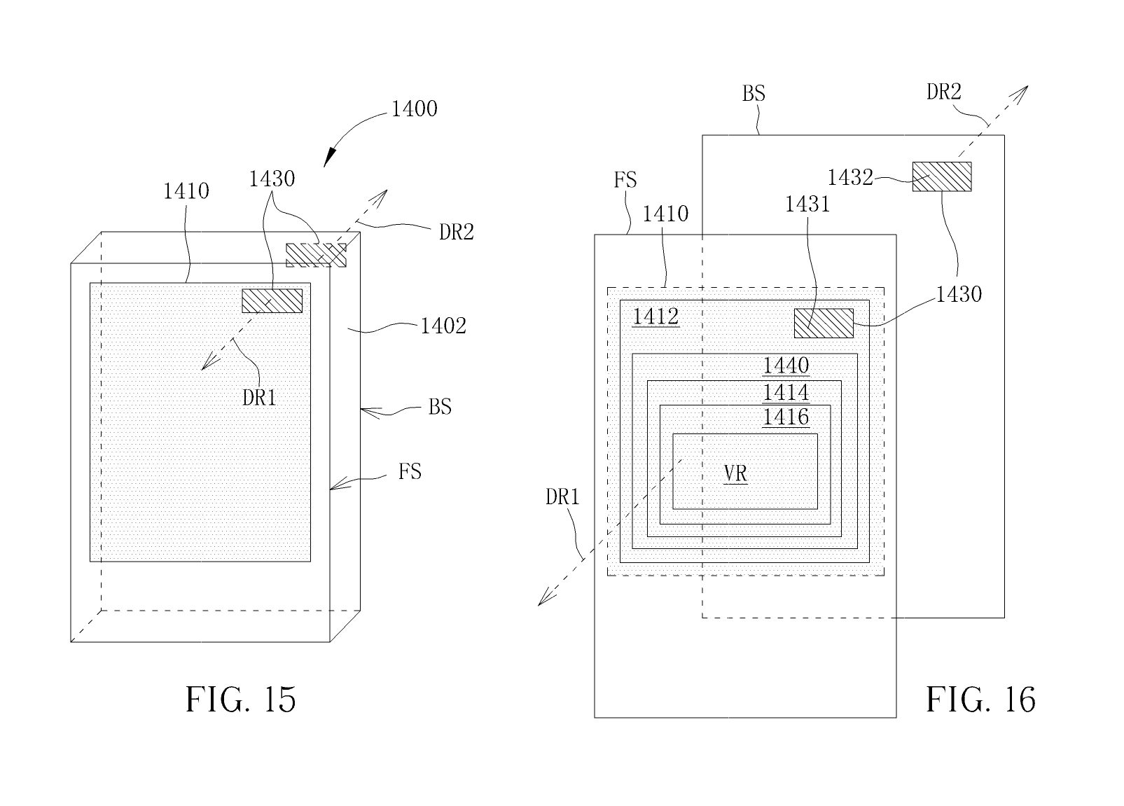

Additionally, the touch panel 1340 shown in FIG. 14 may be integrated in the display panel 1310. Please refer to FIG. 15 and FIG. 16 together. FIG. 15 is a diagram illustrating an exemplary electronic apparatus 1400 according to a second embodiment of the present invention, and FIG. 16 is a diagram illustrating devices on a first surface FS and a second surface BS of the electronic apparatus 1400 shown in FIG. 15. The architecture of the electronic apparatus 1400 is based on that of the electronic apparatus 1300 shown in FIG. 13/FIG. 14. For example, a housing 1402 may be implemented by the housing 1302 shown in FIG. 13, and a wireless circuit 1430 (including a first antenna 1431 and a second antenna 1432) may be implemented by the wireless circuit 1330 shown in FIG. 13/FIG. 14. In this embodiment, the main difference between the electronic apparatus 1300 and the electronic apparatus 1400 is that a touch sensing module 1440 included in the electronic apparatus 1400 is disposed in a position corresponding to the visible region VR in a display panel 1410. Hence, the touch sensing module 1440 and the display panel 1410 may be integrated as a touch display panel. Additionally, the display panel 1410 may further include optical devices such as an array glass 1412, a color filter glass 1414 and an up polarizer 1416.

It should be noted that, in this embodiment, the touch sensing module 1440 is an integrated touch sensing circuit instead of an independent touch panel (e.g. the touch panel 1340 shown in FIG. 14). The touch sensing module 1440 may be disposed on the array glass 1412 or the color filter glass 1414 of the display panel 1410. For example, the touch sensing module 1440 may be integrated within a TFT array on the array glass 1412. In one implementation, the touch sensing module 1440 may be disposed on a top surface or a bottom surface of the color filter glass 1414.

In summary, the present invention provides a touch panel having a wireless circuit (e.g. a circuit having an antenna) integrated therein, a related display apparatus and a related electronic apparatus. Regarding a communication electronic product having a wireless circuit (e.g. a circuit having an antenna, wherein the antenna may be oriented toward the front side and/or the back side of the electronic apparatus), a space for disposing the wireless circuit may be released for further use. Therefore, not only may the size of the communication electronic product be reduced, but the additional cost of special processes may also be saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a substrate;
a sensing circuit, disposed in a first area on a surface of the substrate, for receiving a touch signal on the touch panel; and
a wireless circuit, disposed in a second area on the surface, for transceiving a wireless signal.

2. The touch panel of claim 1, further comprising:
a circuit board module, having a connection part disposed in a third area on the surface of the substrate;
wherein the sensing circuit transmits the touch signal through the circuit board module, and the wireless circuit transceives the wireless signal through the circuit board module.

3. The touch panel of claim 2, wherein the circuit board module comprises:
a flexible printed circuit board, comprising:
a first group of signal traces, for transmitting the touch signal; and
a second group of signal traces, for transmitting the wireless signal.

4. The touch panel of claim 2, wherein the circuit board module comprises:
a first flexible printed circuit board, comprising:
a first group of signal traces, for transmitting the touch signal; and
a second flexible printed circuit board, comprising:
a second group of signal traces, for transmitting the wireless signal.

5. The touch panel of claim 1, wherein the sensing circuit further performs a frequency shifting upon the touch signal.

6. The touch panel of claim 1, wherein the substrate is a touch glass or a cover glass.

7. The touch panel of claim 1, wherein the wireless circuit comprises an antenna.

8. A touch panel, comprising:
a substrate;
a circuit board module, having a connection part disposed in a first area on a surface of the substrate;
a sensing circuit, disposed in a second area on the surface of the substrate, for receiving a touch signal on the touch panel and transmitting the touch signal through the circuit board module; and
a wireless circuit, disposed on the connection part of the circuit board module, for transceiving a wireless signal through the circuit board module.

9. The touch panel of claim 8, wherein the circuit board module comprises:
a flexible printed circuit board, comprising:
a first group of signal traces, for transmitting the touch signal; and
a second group of signal traces, for transmitting the wireless signal.

10. The touch panel of claim 8, wherein the circuit board module comprises:
a first flexible printed circuit board, comprising:
a first group of signal traces, for transmitting the touch signal; and
a second flexible printed circuit board, comprising:
a second group of signal traces, for transmitting the wireless signal.

11. The touch panel of claim 8, wherein the sensing circuit further performs a frequency shifting upon the touch signal.

12. The touch panel of claim 8, wherein the substrate is a touch glass or a cover glass.

13. The touch panel of claim 8, wherein the wireless circuit comprises an antenna.

14. A display apparatus, comprising:
a display panel, having a non-visible region;
a circuit board module, having a connection part disposed in the non-visible region; and
a wireless circuit, disposed in the non-visible region or on the connection part of the circuit board module, for transceiving a wireless signal through the circuit board module.

15. The display apparatus of claim 14, being a touch display apparatus and further comprising a display module and a touch panel, wherein the display module comprises the display panel, the circuit board module and the wireless circuit, the display panel further has a visible region, and the touch panel is disposed in the visible region.

16. The display apparatus of claim 14, wherein the wireless circuit comprises an antenna.

17. The display apparatus of claim 14, being a touch display apparatus and further comprising a touch sensing module, wherein the display panel further has a visible region, and the touch sensing module is disposed correspondingly to the visible region in the display panel.

18. The display apparatus of claim 17, wherein the display panel comprises an array glass, and the touch sensing module is disposed on the array glass.

19. The display apparatus of claim 17, wherein the display panel comprises a color filter glass, and the touch sensing module is disposed on the color filter glass.

20. The display apparatus of claim 17, wherein the wireless circuit comprises an antenna.

21. A display apparatus, comprising:
a housing, having a first surface and a second surface opposed to the first surface;
a display panel, disposed on the first surface, the display panel having a non-visible region; and
a wireless circuit, including a first antenna and a second antenna, wherein the first antenna is disposed in the non-visible region and near the first surface, the second antenna is disposed near the second surface, and the wireless circuit is arranged for transceiving a wireless signal selectively in the direction of the first surface through the first antenna or in the direction of the second surface through the second antenna.

22. The electronic apparatus of claim 21, being a touch display apparatus and further comprising a display module and a touch panel, wherein the display module comprises the display panel and the wireless circuit, the display panel further has a visible region, and the touch panel is disposed in the visible region.

23. The electronic apparatus of claim 21, wherein each of the first antenna and the second antenna is a near field communication antenna device.

24. The electronic apparatus of claim 21, being a touch display apparatus and further comprising a touch sensing module, wherein the display panel further has a visible region, and the touch sensing module is disposed correspondingly to the visible region in the display panel.

25. The electronic apparatus of claim 24, wherein the display panel comprises an array glass, and the touch sensing module is disposed on the array glass.

26. The electronic apparatus of claim 24, wherein the display panel comprises a color filter glass, and the touch sensing module is disposed on the color filter glass.
